(19) United States
(12) Patent Application Publication
(10) Pub. No.: US 2016/0313853 A1
(43) Pub. Date: Oct. 27, 2016

(54) SENSING DEVICE

(71) Applicant: Industrial Technology Research Institute, Hsinchu (TW)

(72) Inventors: Ying-Ting Liou, Hsinchu County (TW); Chih-Chia Chang, Hsinchu County (TW); Yi-Chuan Lu, Kinmen County (TW); Yi-Shou Tsai, Taipei City (TW); Kuo-Chang Lee, Pingtung County (TW)

(21) Appl. No.: 15/135,560

(22) Filed: Apr. 22, 2016

Related U.S. Application Data
(60) Provisional application No. 62/150,859, filed on Apr. 22, 2015.

(30) Foreign Application Priority Data
Jan. 5, 2016 (TW) 105100175

(51) Int. Cl. G06F 3/041; G06F 3/044

(52) U.S. Cl. CPC G06F 3/0416; G06F 3/044; G06F 2203/04107

(57) ABSTRACT

According an embodiment of the present disclosure, a sensing device including a substrate, a light shielding layer, a support structure and an intermediate layer is provided. The light shielding layer is disposed on the substrate and has a plurality of first openings. The support structure is disposed on the substrate and has a plurality of second openings. A projection area of each first opening overlaps a projection area of one second opening. The light shielding layer is located between the support structure and the substrate. The intermediate layer is disposed between the light shielding layer and the support structure, wherein at least one of the light shielding layer and the support structure is conductive and includes a plurality of first electrode patterns separated from one another.

### CROSS-REFERENCE TO RELATED APPLICATION

This application claims the priority benefits of U.S. provisional application Ser. No. 62/150,859, filed on Apr. 22, 2015 and Taiwan application serial no. 105100175, filed on Jan. 5, 2016. The entirety of each of the above-mentioned patent applications is hereby incorporated by reference herein and made a part of this specification.

### TECHNICAL FIELD

The present disclosure relates to a sensing device.

### BACKGROUND

In recent years, as information technology, wireless mobile communication and information appliances have been rapidly developed and applied, to achieve more convenience, more compact and light volume, capability of being bended and more user-friendly designs, and various information products have changed from using input devices such as key boards or mice to using sensing devices such as touch panels as input devices. When the touch panel is integrated in a display device, the touch panel may be disposed in front of the display device to provide for the users to operate with screens. However, the impact of an external knocking or/and striking force on the whole device would damage a display screen of the display device, which affects the display effect of the display device. Therefore, the application of a touch panel having anti-impact ability to the display device to prevent the elements for displaying images from being damaged and maintain visual effects of the display screen is an issue.

### SUMMARY

In an embodiment of the present disclosure, a sensing device may include a substrate, a light shielding layer, a support structure, and an intermediate layer. The light shielding layer is disposed on the substrate and has a plurality of first openings. The support structure is disposed on the substrate and has a plurality of second openings. A projection area of each first opening overlaps a projection area of one second opening. The light shielding layer is located between the support structure and the substrate. The intermediate layer is disposed between the light shielding layer and the support structure, wherein at least one of the light shielding layer and the support structure is conductive and includes a plurality of first electrode patterns separated from one another.

In another embodiment of the present disclosure, a sensing device may include a substrate, a light shielding layer, a support structure, a cover layer, and a first conductive layer. The light shielding layer is disposed on the substrate and has a plurality of first openings. The support structure is disposed on the substrate. The light shielding layer is located between the support structure and the substrate. The support structure has a plurality of second openings. A projection area of each first opening overlaps a projection area of one second opening. The cover layer covers the support structure and fills in the second opening. A Young's modulus of the support structure is greater than a Young's modulus of the cover layer. The first conductive layer is disposed between the cover layer and the substrate, wherein the first conductive layer includes a plurality of first electrode patterns separated from one another.

To make the present disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view of a sensing device according to a first embodiment of the present disclosure.

FIG. 2A is a schematic cross-sectional view of the sensing device of FIG. 1 along line I-I.

FIG. 2B is a variant embodiment of the sensing device of FIG. 2A.

FIG. 3A is a schematic top view of a light shielding layer of the sensing device of FIG. 1.

FIG. 3B is a schematic top view of a support structure of the sensing device of FIG. 1.

FIG. 3C is a partial schematic view of a support structure of an embodiment of the present disclosure.

FIG. 4 is a schematic cross-sectional view of a display device according to an embodiment of the present disclosure.

FIG. 5 is a schematic top view of a sensing device according to a second embodiment of the present disclosure.

FIG. 6 is a schematic cross-sectional view of the sensing device of FIG. 5 along line II-II

FIG. 7 is a schematic top view of a sensing device according to a third embodiment of the present disclosure.

FIG. 8 is a schematic cross-sectional view of the sensing device of FIG. 7 along line

FIG. 9 is a variant embodiment of the sensing device of FIG. 8.

FIG. 10 is a variant embodiment of the sensing device of FIG. 9.

FIG. 11 is a variant embodiment of the sensing device of FIG. 9.

FIG. 12 is a schematic top view of a sensing device according to a fourth embodiment of the present disclosure.

FIG. 13 is a schematic cross-sectional view of the sensing device of FIG. 12 along line IV-IV.

FIG. 14 is a schematic top view of a sensing device according to a fifth embodiment of the present disclosure.

FIG. 15 is a schematic cross-sectional view of the sensing device of FIG. 14 along line V-V.

FIG. 16 is a variant embodiment of the sensing device of FIG. 15.

FIG. 17 is a schematic top view of a sensing device according to a sixth embodiment of the present disclosure.

FIG. 18 is a schematic cross-sectional view of the sensing device of FIG. 17 along line VI-VI.

FIG. 19 is a schematic top view of a sensing device according to a seventh embodiment of the present disclosure.

FIG. 20 is a schematic cross-sectional view of the sensing device of FIG. 19 along line VII-VII.

### DETAILED DESCRIPTION

In the following detailed description, for purposes of explanation, numerous details are set forth in order to provide a thorough understanding of the disclosed embodiments. It will be clear, however, that one or more embodiments may be practiced without these details. In other instances, well-known structures and devices are schematically shown in order to simplify the drawing.

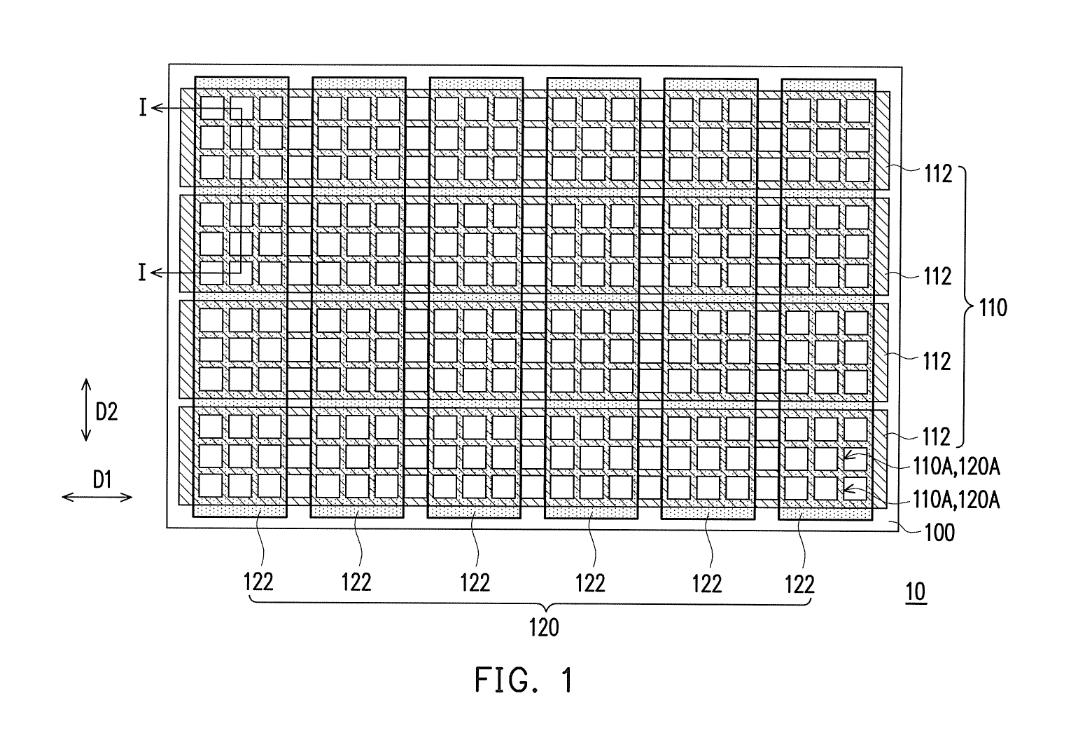

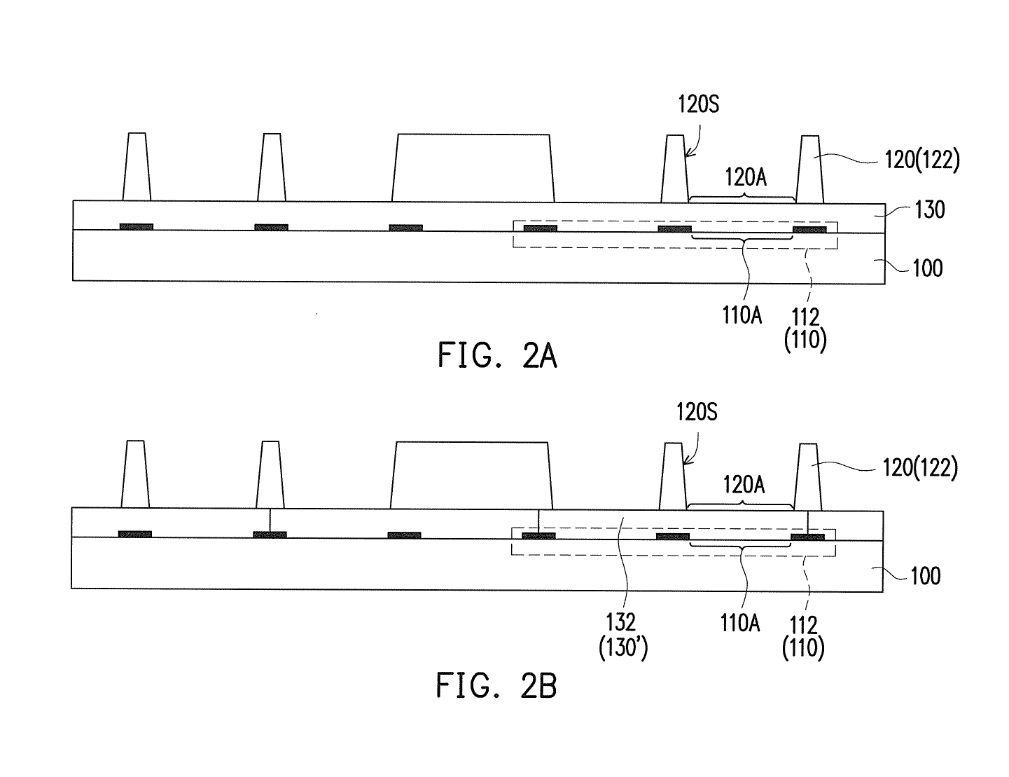

FIG. 1 is a schematic view of a sensing device according to a first embodiment of the present disclosure. FIG. 2A is a schematic cross-sectional view of the sensing device of FIG. 1 along line I-I. Referring to FIG. 1 and FIG. 2A, a sensing device 10 may include a substrate 100, a light shielding layer 110, a support structure 120, and an intermediate layer 130. The light shielding layer 110 is located between the support structure 120 and the substrate 100, and the intermediate layer 130 is located between the light shielding layer 110 and the support structure 120. In the embodiment, the light shielding layer 110 has a plurality of first openings 110A, and the first openings 110A may be arranged in an array on the substrate 100. The first openings 110A may be shaped in rectangles, squares, circles, honey comb-like shapes, or other shapes. The support structure 120 has a plurality of second openings 120A. The second openings 120A may be shaped in rectangles, squares, circles, honey comb-like shapes, or other shapes, and a projection area of each second opening 120A overlaps a projection area of one first opening 110A, wherein the projection area is an area enclosed by a profile of each opening projected onto the substrate when a light beam passes through each opening and irradiates on the substrate in a direction perpendicular to the substrate, for example. In terms of FIG. 1, each second opening 120A and one corresponding first opening 110A may have a similar size, and the profiles of the two openings may overlap in FIG. 1. However, in other embodiments, each second opening 120A and one corresponding first opening 110A may have different sizes or shapes. For example, the projection area of the first opening 110A may overlap the projection area of the corresponding second opening 120A in an area ratio equal to or more than 50% of the area of the first opening 110A. In one embodiment, a material of the support structure 120 may be conductive material with Young's modulus larger than 10 MPa, for example, metal. In addition, the light shielding layer 110 and the support structure 120 in the embodiment may be composed of a conductive material such as metal. The intermediate layer 130 disposed between the light shielding layer 110 and the support structure 120 may provide an isolation function. Thus, the light shielding layer 110 and the support structure 120 after being patterned may be used as touch electrodes and a touch capacitance may be formed between the light shielding layer 110 and the support structure 120.

Additionally, FIG. 2B is a variant embodiment of the sensing device of FIG. 2A. In FIG. 2B, the sensing device 10 may include the substrate 100, the light shielding layer 110, the support structure 120, and an intermediate layer 130′, wherein the intermediate layer 130′ may be a color filter layer. Also, the intermediate layer 130′ may include a plurality of color filter patterns 132. That is, the intermediate layer 130′ may not only provide an isolation function but also provide a color filter effect.

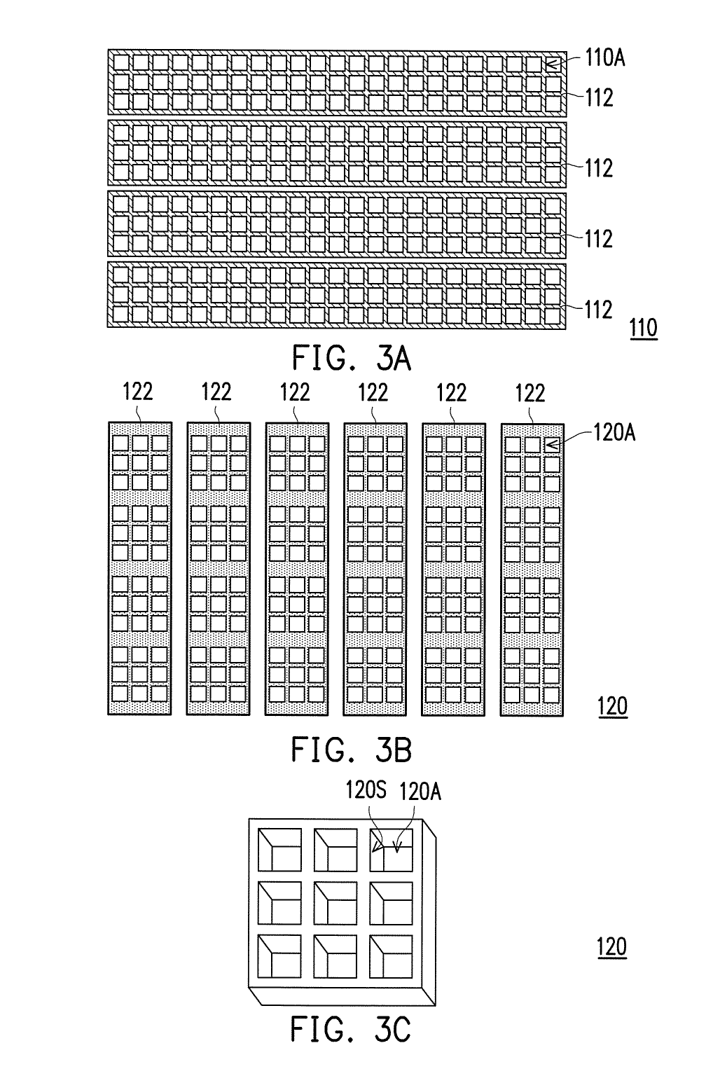

FIG. 3A is a schematic top view of a light shielding layer of the sensing device of FIG. 1. From FIG. 1 and FIG. 3A, the light shielding layer 110 includes a plurality of first electrode patterns 112 independently of each other. The first electrode pattern 112 may be a pattern extending along a first direction D1, wherein a shape thereof may be such as a stripe shape, a bamboo-like shape, a wavy shape, or a zigzag shape, etc., and may be independent of other first electrode patterns 112 substantially. The plurality of first electrode patterns 112 may be independent of one another in electrical property.

FIG. 3B is a schematic top view of a support structure of the sensing device of FIG. 1. From FIG. 1 and FIG. 3B, the support structure 120 includes a plurality of second electrode patterns 122 separated from one another. The second electrode pattern 122 may be a pattern extending along a second direction D2, wherein a pattern thereof may be a stripe shape, a bamboo-like shape, a wavy shape, or a zigzag shape, etc., and may be independent of other second electrode patterns 122 substantially. The plurality of second electrode patterns 122 may be independent of one another in electrical property. In addition, from FIG. 1, the first direction D1 and the second direction D2 may intersect with each other, and the first electrode patterns 112 may be interleaved with the second electrode patterns 122. From FIG. 2, the intermediate layer 130 having an isolation effect may be located between the first electrode patterns 112 and the second electrode patterns 122. A touch capacitance may be generated between the first electrode patterns 112 and the second electrode patterns 122 in the sensing device 10 to achieve a touch sensing function.

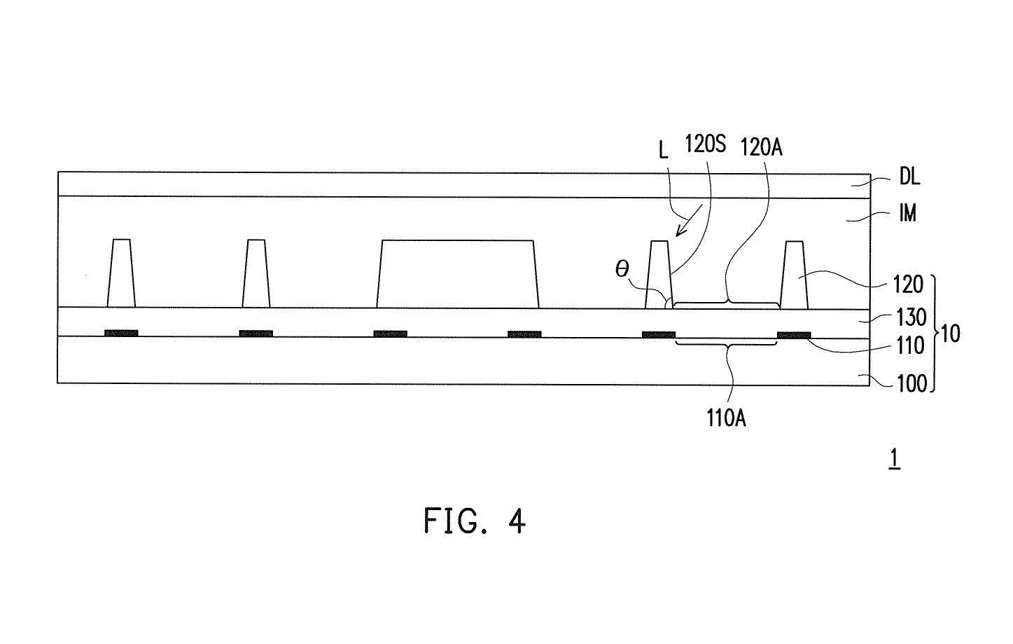

FIG. 3C is a partial schematic view of a support structure of an embodiment of the present disclosure. From FIG. 2A, 2B and 3C, in the embodiment, the support structure 120 may provide light guiding function as well as support function, and the support structure 120 has a sidewall 120S at each second opening 120A so that an area of the second opening 120A gradually increases from a side close to the substrate 100 to an opposite side away from the substrate 100. In addition, an angle θ between the sidewall 120S and a top surface of the intermediate layer 130 is less than 90 degrees, such as from 55 degrees to 85 degrees so as to provide the support function and the light guiding function. Additionally, the angle θ between the sidewall 120S and a top surface of the intermediate layer 130 may not be limited to be less than 90 degrees. The support structure 120 for having the support function. In one embodiment, as shown in FIG. 4, a cover layer IM and a display layer DL may be disposed on the sensing device 10 to form a display device 1. The cover layer IM may cover the support structure 120, and Young's modulus of the cover layer IM may be smaller than Young's modulus of the support structure 120. The cover layer IM may serve as a buffer layer capable of absorbing the impact of an external force to prevent from the damage of the inner elements of the display layer DL. Furthermore, the cover layer IM may have a planar surface for disposing the display layer DL thereon. The display layer DL may be a self-luminous display layer or a non-self-luminous display layer. The self-luminous display layer may include an organic luminous layer, etc., for example. The non-self-luminous display layer may include a liquid crystal layer, an electrophoresis display layer, or an electrowetting display layer, etc., for example. When the display layer DL is a non-self-luminous display layer, the display device 1 may further include a light source to provide light for display.

In one embodiment, the support structure 120 may be composed of a metal material having high Young's modulus and high light reflection property. In this way, light L emitted from the display layer DL may be reflected on the sidewall 120S and emitted toward to the first opening 110A. In other words, the light L may be centralized in and emitted out from the first opening 110A by the guiding of the support structure 120 when the display device 1 is used in the display screen. Thus, display contrast and brightness presented by the display device 1 may be enhanced. When the ambient brightness is high, the user may see the displayed image on the display device 1, and the display performance of the display device 1 is enhanced.

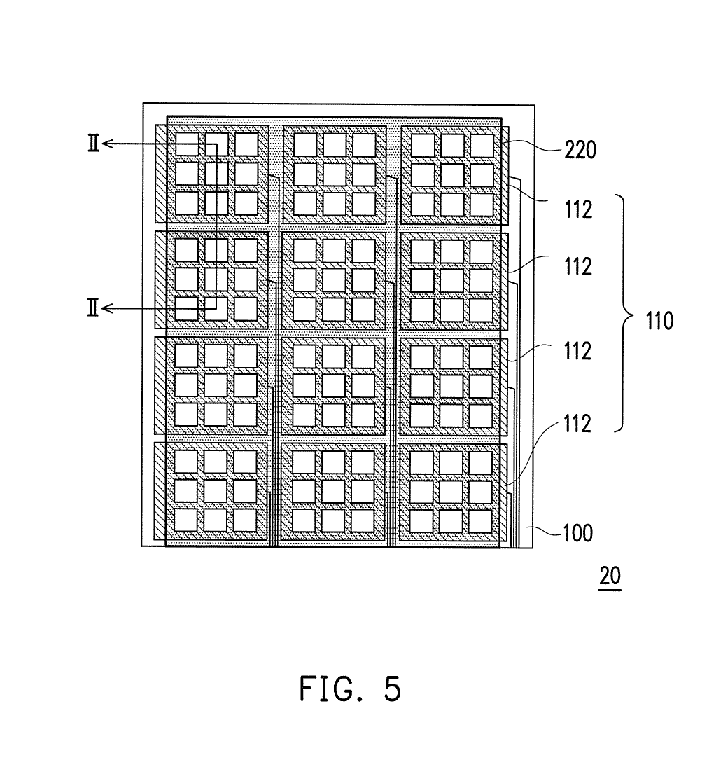

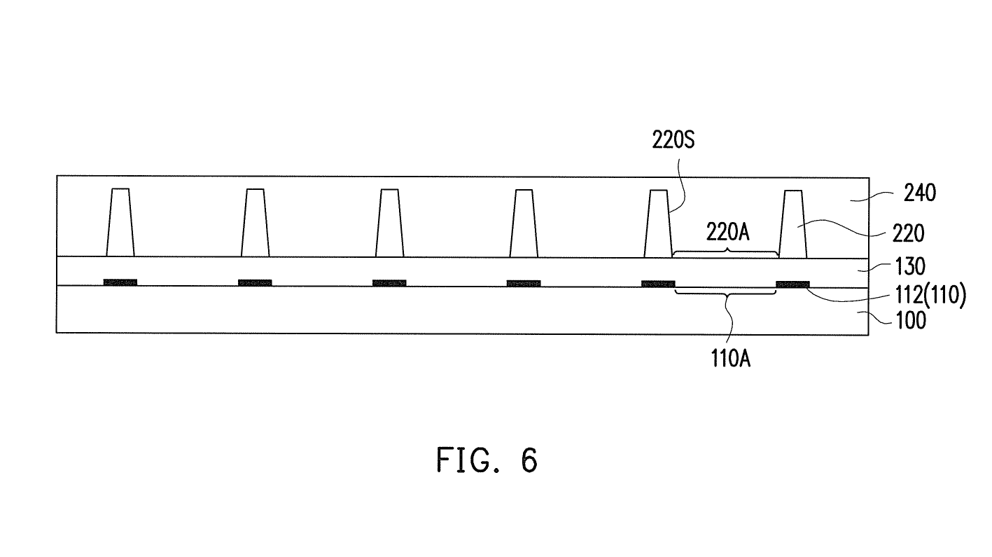

FIG. 5 is a schematic top view of a sensing device according to a second embodiment of the present disclosure. FIG. 6 is a schematic cross-sectional view of the sensing device of FIG. 5 along line II-II. Referring to FIG. 5 and FIG. 6 at the same time, a sensing device 20 includes the substrate 100, the light shielding layer 110, a support structure 220, the intermediate layer 130, and a cover layer 240. In the embodiment, designs and materials of the substrate 100, the light shielding layer 110, and the intermediate layer 130 may be similar to the above-mentioned embodiments, thus the above components may be represented by the same component symbol as those in the previous embodiment. The intermediate layer 130 may include a plurality of color filter patterns referring to the intermediate layer 130′ of FIG. 2B. In addition, the support structure 220 of the embodiment may be composed of an insulation material with high Young's modulus (for example, >10 MPa). Serving as a structure having support function, the support structure 220 is not used as a touch sensing electrode. That is, the sensing device 20 may be a single-layer electrode touch panel, and a touch electrode thereof is achieved by the first electrode pattern 112 of the light shielding layer 110, which is also called as a one layer solution (OLS) scheme. The support structure 220 of the embodiment is not used as a touch electrode, thus the support structure 220 may include a plurality of column structures independently arranged. The shapes of the column structures are not limited to circular cylinders, semi-spheres, rectangular cylinders, or the like. Alternatively, the support structure 220 is not required to pattern into a plurality of independent electrode patterns but may be a continuous and repeatable lattice-shaped structure. A profile of the first electrode pattern 112 illustrated in the embodiment is a square profile, but the profile of the first electrode pattern 112 is not specifically limited in other embodiments. For example, the profile of the first electrode pattern 112 may be an arbitrary polygon. In addition, every first electrode pattern 112 of the light shielding layer 110 may form a sensing unit to perform a self-capacitance sensing function. However, a portion of the first electrode patterns 112 of the light shielding layer 110 may be selected to be used as driving electrodes, and another portion thereof may be used as sensing electrodes, so that one driving electrode is disposed adjacent to one sensing electrode to perform a mutual capacitance sensing function.

As shown in FIG. 5, the support structure 220 may be a continuous and repeatable lattice-shaped pattern or independent column structures in the top view. However, similar to the above-mentioned embodiments, the support structure 220 has a plurality of second openings 220A, and a projection area of each second opening 220A respectively overlaps a projection area of one first opening 110A of the light shielding layer 110. The projection area here refers to an area of component perpendicularly projected onto the substrate 100. In addition, the cover layer 240 covers the support structure 220 and fills in the second opening 220A. The support structure 220 has a sidewall 220S at the second opening 220A. The sidewall 220S can be sloped or not. Young's modulus of the support structure 220 is greater than Young's modulus of the cover layer 240. Under an impact of an external force or a heavy pressing pressure, the support structure 220 may provide the support function accompanying with the buffer function of the cover layer 240, so that the external force may be absorbed and the damage of the electronic elements may be prevented. A refractive index of the support structure 220 may be less than a refractive index of the cover layer 240, and a difference between the refractive index of the cover layer 240 and the refractive index of the support structure 220 may be equal to or more than 0.3, for example. In one embodiment, the refractive index of the support structure 220 may be from 1.0 to 1.7, and the refractive index of the cover layer 240 may be from 1.3 to 2.0. By the selection of the material in the embodiment, the refractive index of the support structure 220 is less than the refractive index of the cover layer 240. For example, a difference between the refractive index of the support structure 220 and that of the cover layer 240 may be 0.3, and an angle between the sidewall 220S and the top surface of the intermediate layer 130 is less than 90 degrees, such as from 55 degrees to 85 degrees. When the sensing device 20 is applied to the display device 1 as shown in FIG. 4 and substituted for the sensing device 10 of FIG. 4, disposition of the support structure 220 and the cover layer 240 may guide the light L emitted from the display layer DL to emit out from the first opening 110A, so as to enhance the display performance of the display device.

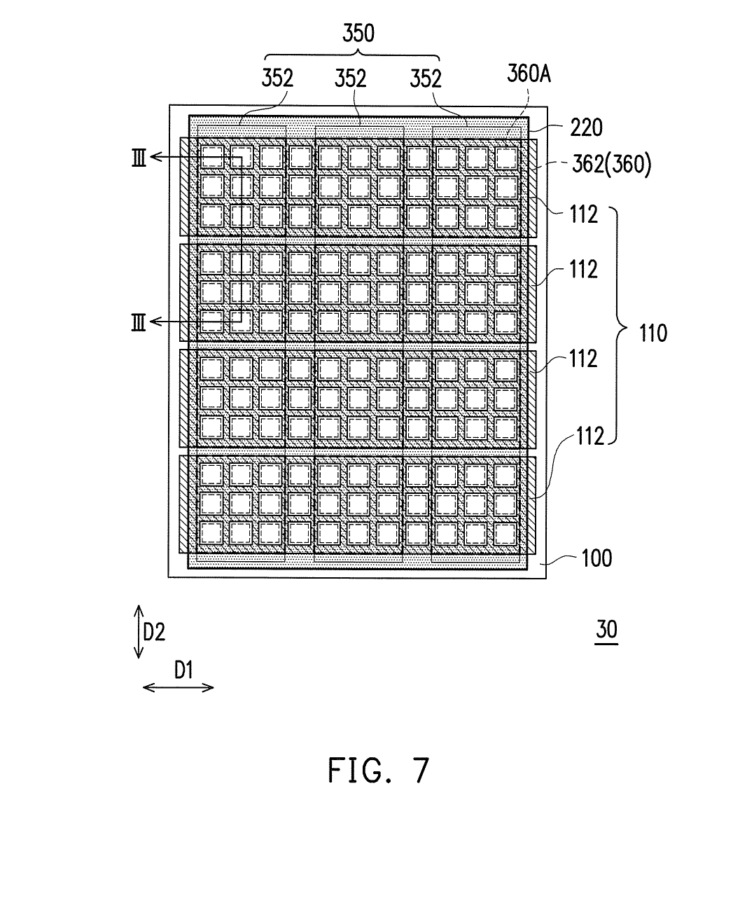

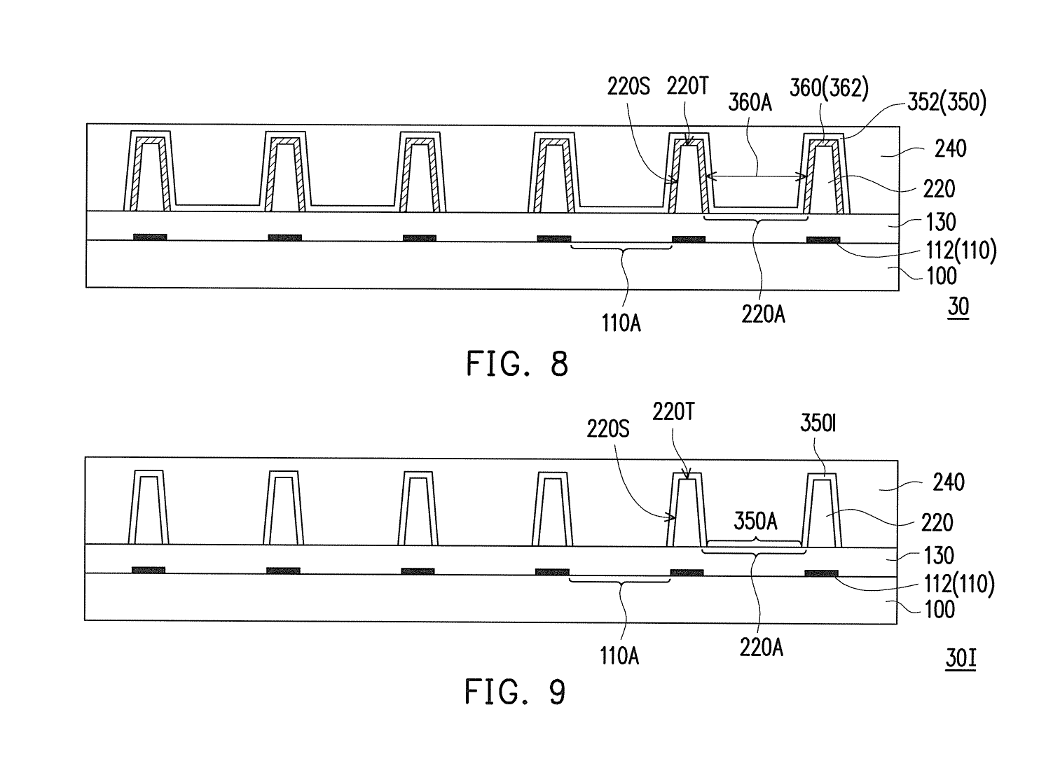

FIG. 7 is a schematic top view of a sensing device according to a third embodiment of the present disclosure. FIG. 8 is a schematic cross-sectional view of the sensing device of FIG. 7 along line III-III. Referring to FIG. 7 and FIG. 8 at the same time, a sensing device 30 may include the components of the sensing device 20 as shown in FIG. 5, and further include a conductive layer 350 and a reflection layer 360. The reflection layer 360 is disposed between the conductive layer 350 and the support structure 220. The conductive layer 350 covers the support structure 220, so that the support structure 220 is disposed between the conductive layer 350 and the intermediate layer 130. The structures, materials, and functions of the substrate 100, the light shielding layer 110, the support structure 220, the intermediate layer 130, and the cover layer 240 of the embodiment may be understood with reference to the related descriptions of FIG. 5 and FIG. 6. At the same time, the intermediate layer 130 may include a plurality of color filter patterns referring to the intermediate layer 130′ of FIG. 2B. In the embodiment, the conductive layer 350 includes a plurality of second electrode patterns 352 used as touch sensing electrodes. The second electrode patterns 352 may be strip-shaped patterns respectively, for example. The first electrode pattern 112 of the light shielding layer 110 extends along the first direction D1, and the second electrode pattern 352 of the conductive layer 350 extends along the second direction D2. The first direction D1 and the second direction D2 may intersect with each other. The intermediate layer 130 used for isolation may be located between the first electrode pattern 112 and the second electrode pattern 352. A touch capacitance may be generated between the first electrode pattern 112 and the second electrode pattern 352 in the sensing device 30 to achieve a touch sensing function. That is, the sensing device 30 of the embodiment may be a bilayer touch electrode sensing device. In the embodiment, the conductive layer 350 may be composed of a transparent conductive material. A portion of an area of the conductive layer 350 may be within the second opening 220A. The reflection layer 360 includes a plurality of reflection patterns 362 corresponding to the second electrode patterns 352. In FIG. 8, the reflection layer 360 may cover a top surface 220T of the support structure 220 and the sidewall 220S approximately and have a plurality of reflection layer openings 360A, wherein the reflection layer openings 360A overlap the second openings 220A for light penetration. The reflection layer 360 is not required to be disposed between the conductive layer 350 and the support structure 220. In other words, the conductive layer 350 may be disposed between the reflection layer 360 and the support structure 220 in other embodiments. That is, the stacking order of the conductive layer 350 and the reflection layer 360 in FIG. 8 may be exchanged.

FIG. 9 is a variant embodiment of the sensing device of FIG. 8. Referring to FIG. 9, a conductive layer 350I of a sensing device 30I has a plurality of third openings 350A, which may be composed of a metal material, for example. The conductive layer 350I can provide the light reflection effect such that the sensing device 30I may selectively not be equipped with the reflection layer 360 of FIG. 7 and FIG. 8. A projection area of each third opening 350A on the substrate 100 may overlap a projection area of one first opening 110A on the substrate 100 and overlap a projection area of one second opening 220A on the substrate 100. In addition, from FIG. 9, the conductive layer 350I may cover the top surface 220T and the sidewall 220S of the support structure 220 approximately. Sizes of the first opening 110A, the second opening 220A, and the third opening 350A may be the same or different, but at least some of them are overlapped. In the embodiment, a material of the conductive layer 350I may be a conductive material having reflection property. When the sensing device 30I is applied to a display device, the conductive layer 350I may reflect the light from a display panel to enhance display light-emitting efficiency of the overall device.

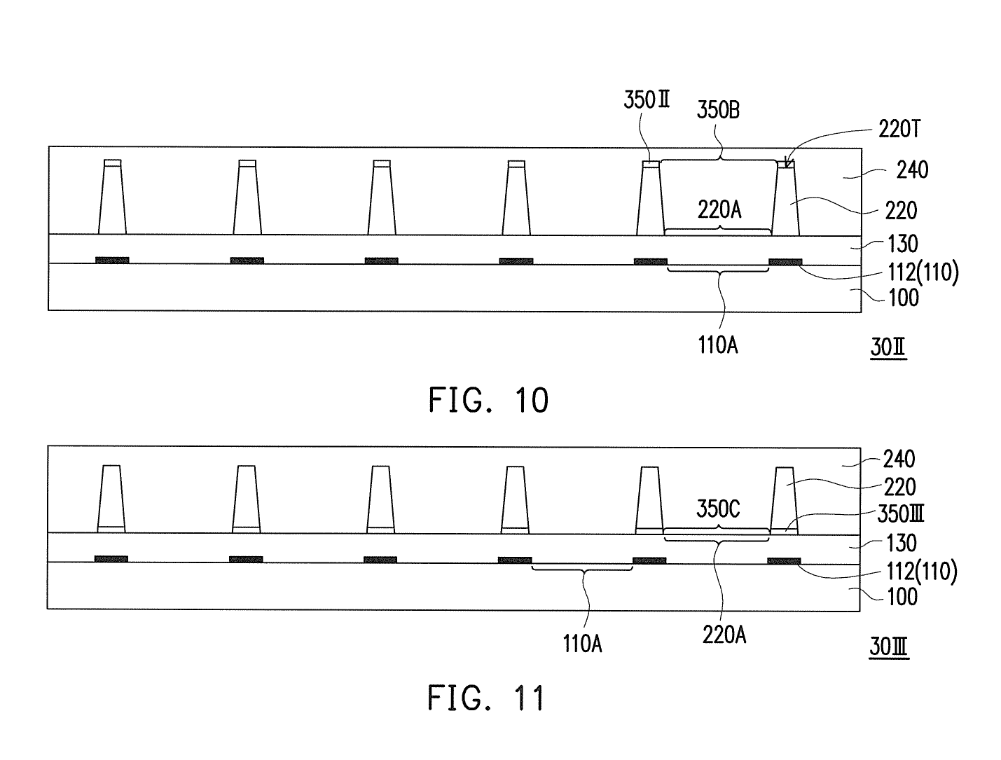

FIG. 10 is a variant embodiment of the sensing device of FIG. 9. Referring to FIG. 10, a conductive layer 350II of a sensing device 30II has a plurality of third openings 350B, which may be composed of a metal material, for example. The conductive layer 350II may provide the light reflection effect such that the sensing device 30II may have no reflection layer 360 of FIG. 7 and FIG. 8. A projection area of each third opening 350B may overlap a projection area of one first opening 110A and overlap a projection area of one second opening 220A. From FIG. 10, the conductive layer 350II may cover the top surface 220T of the support structure 220 approximately. In the embodiment, a material of the conductive layer 350II may be a conductive material having reflection property. When the sensing device 30II is applied to a display device, the conductive layer 350II may reflect the light from a display panel to enhance display light-emitting efficiency of the overall device.

FIG. 11 is a variant embodiment of the sensing device of FIG. 9. Referring to FIG. 11, a conductive layer 350III of a sensing device 30III is located between the support structure 220 and the intermediate layer 130 and has a plurality of third openings 350C. A projection area of each third opening 350C may overlap a projection area of one first opening 110A and overlap a projection area of one second opening 220A.

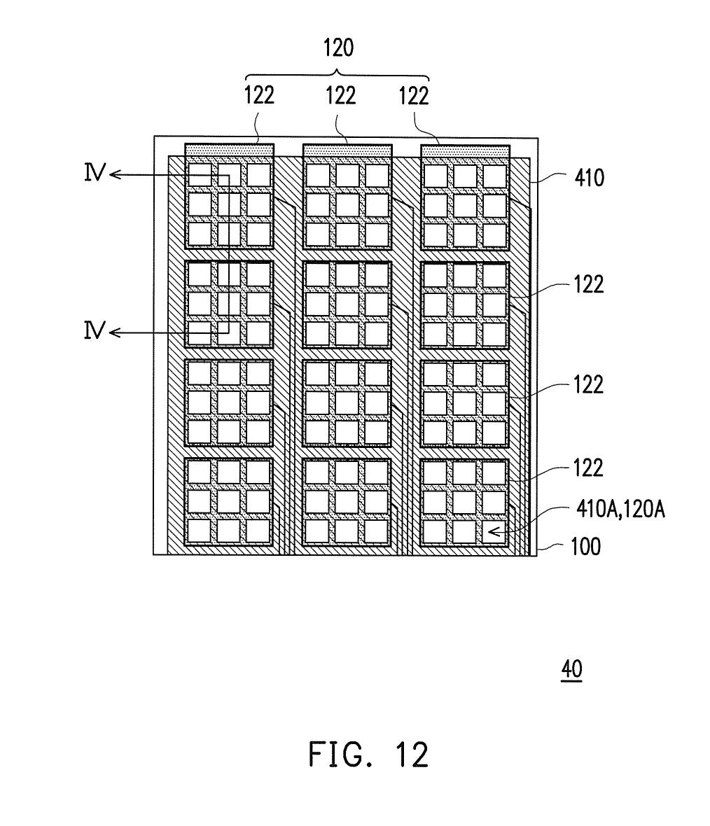

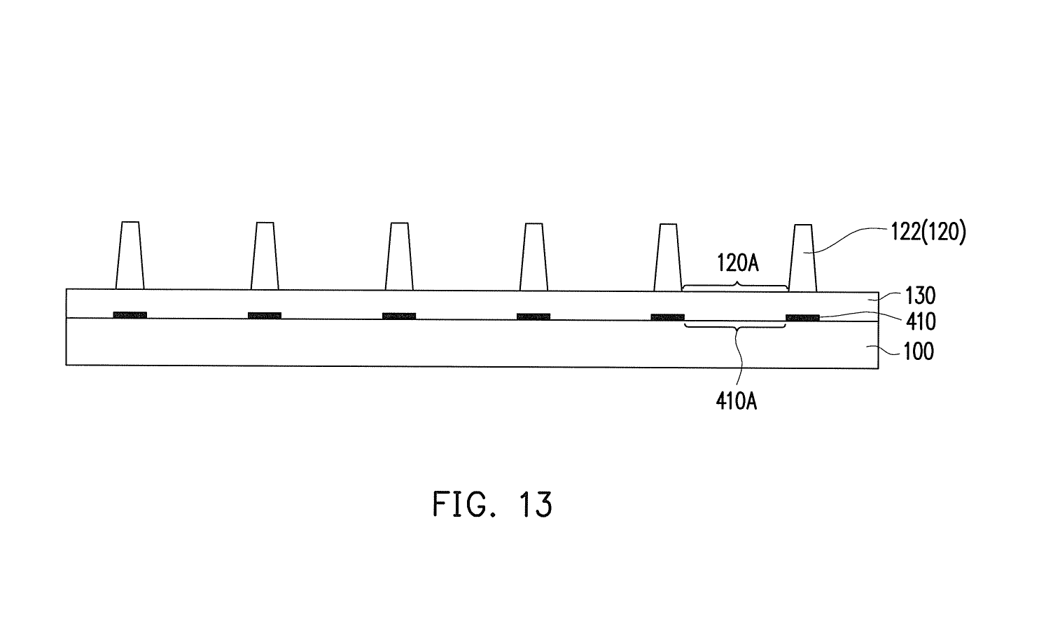

FIG. 12 is a schematic top view of a sensing device according to a fourth embodiment of the present disclosure. FIG. 13 is a schematic cross-sectional view of the sensing device of FIG. 12 along line IV-IV. Referring to FIG. 12 and FIG. 13 at the same time, a sensing device 40 includes the substrate 100, a light shielding layer 410, the support structure 120, and the intermediate layer 130. In the embodiment, designs and materials of the substrate 100, the support structure 120, and the intermediate layer 130 may be similar to the above-mentioned embodiments, thus the above components may be represented by the same component symbols. The intermediate layer 130 may include a plurality of color filter patterns referring to the intermediate layer 130′ of FIG. 2B. In addition, the light shielding layer 410 of the embodiment may be composed of an insulation material. The light shielding layer 410 is not used as a touch sensing electrode. As shown in FIG. 12, the light shielding layer 410 may be a continuous and uninterrupted lattice-shaped pattern in the top view. The light shielding layer 410 has a plurality of first openings 410A, and a projection area of each second opening 120A on the substrate 100 may respectively and correspondingly overlaps a projection area of one first opening 410A of the light shielding layer 410 on the substrate 100. The sensing device 40 may be a single-layer electrode (e.g. one layer solution, OLS) touch panel. A touch electrode thereof is achieved by the second electrode pattern 122 of the support structure 120. The light shielding layer 410 of the embodiment is not used as a touch electrode, the light shielding layer 410 is not required to be patterned into a plurality of independent electrode patterns. A profile of the second electrode pattern 122 is illustrated by a square profile in the embodiment, but the profile of the second electrode pattern 122 of the support structure 120 is not specifically limited in other embodiments. For example, the profile of the second electrode pattern 122 may be an arbitrary polygon. In addition, every second electrode pattern 122 of the support structure 120 may serve as a sensing unit to perform a self-capacitance sensing function. However, a portion of the second electrode pattern 122 of the support structure 120 may be selected to be used as a driving electrode, and another portion thereof may be used as a sensing electrode, so that one drive electrode is disposed adjacent to one sensing electrode to perform a mutual capacitance sensing function.

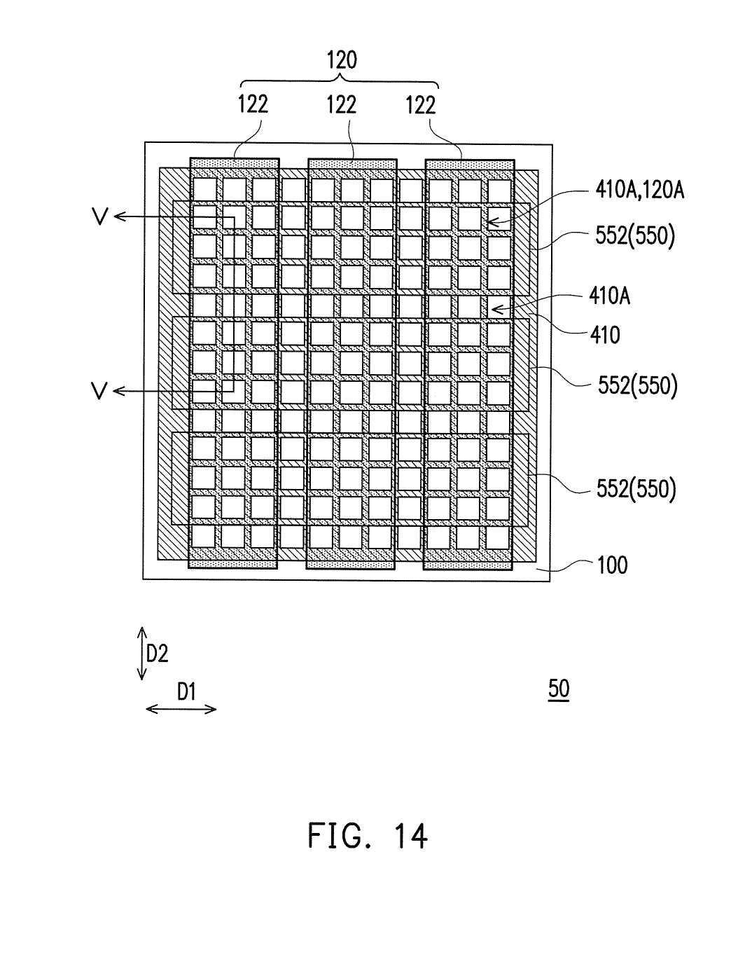

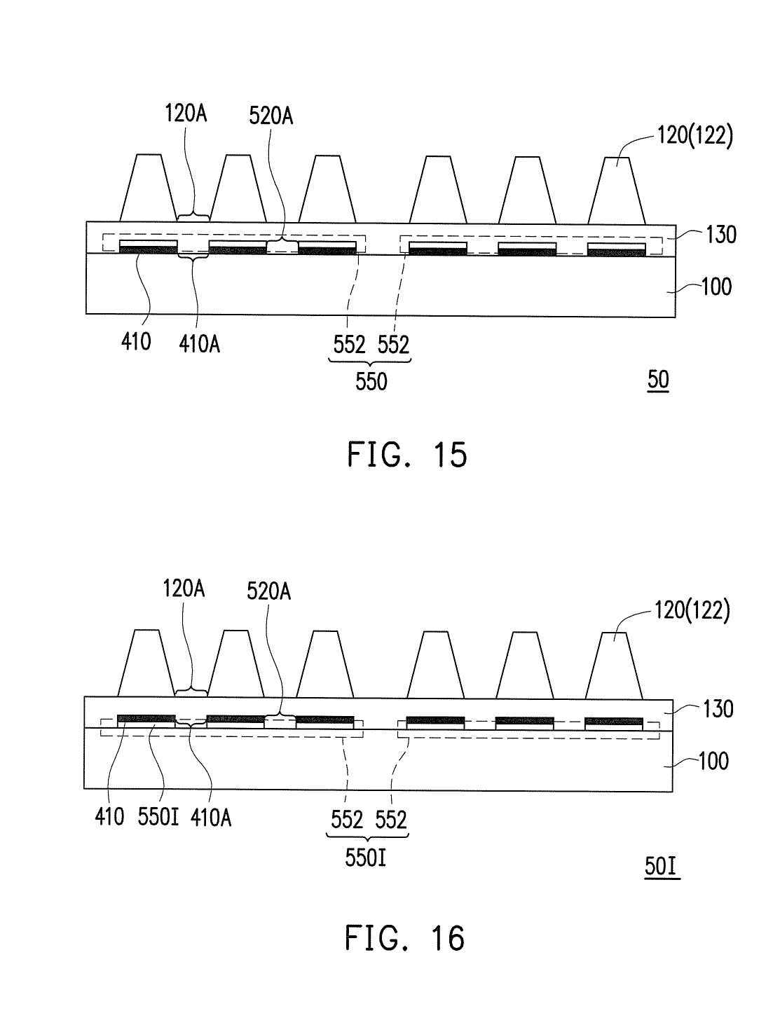

FIG. 14 is a schematic top view of a sensing device according to a fifth embodiment of the present disclosure. FIG. 15 is a schematic cross-sectional view of the sensing device of FIG. 14 along line V-V. Referring to FIG. 14 and FIG. 15 at the same time, a sensing device 50 may include the components of the sensing device 40 as shown in FIG. 12, and further include a conductive layer 550, wherein the conductive layer 550 is sandwiched between the light shielding layer 410 and the intermediate layer 130. The structures, materials, and functions of the substrate 100, the light shielding layer 410, the support structure 120, and the intermediate layer 130 of the embodiment may be understood with reference to the related descriptions of FIG. 12 and FIG. 13. The intermediate layer 130 may include a plurality of color filter patterns referring to the intermediate layer 130′ of FIG. 2B. In the embodiment, the conductive layer 550 includes a plurality of first electrode patterns 552 used as touch sensing electrodes. The first electrode patterns 552 may be strip-shaped patterns respectively and extends along the first direction D1. The second electrode patterns 122 of the support structure 120 extends along the second direction D2. The first direction D1 and the second direction D2 may intersect with each other. The intermediate layer 130 used for isolation is located between the first electrode patterns 552 and the second electrode patterns 122. A touch capacitance may be generated between the first electrode pattern 552 and the second electrode pattern 122 in the sensing device 50 to achieve a touch sensing function. The sensing device 50 of the embodiment may be a dual layer touch electrode touch panel. In the embodiment, the conductive layer 550 may be composed of a transparent conductive material. Thus, the conductive layer 550 has a third opening 520A corresponding to the first opening 410A in FIG. 15, but a portion of the conductive layer 550 may be located in the first opening 410A in other embodiments. Additionally, FIG. 16 is a variant embodiment of the sensing device of FIG. 15. Referring to FIG. 16, a sensing device 50I may be similar to the sensing device 50. The light shielding layer 410 of the sensing device 50I is located between a conductive layer 550I and the intermediate layer 130.

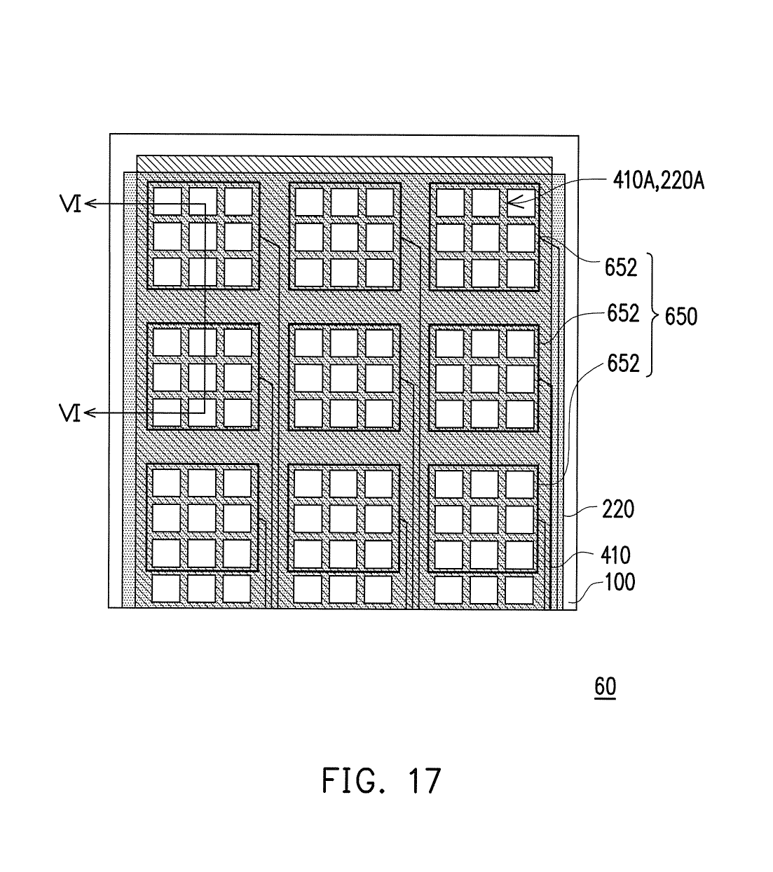

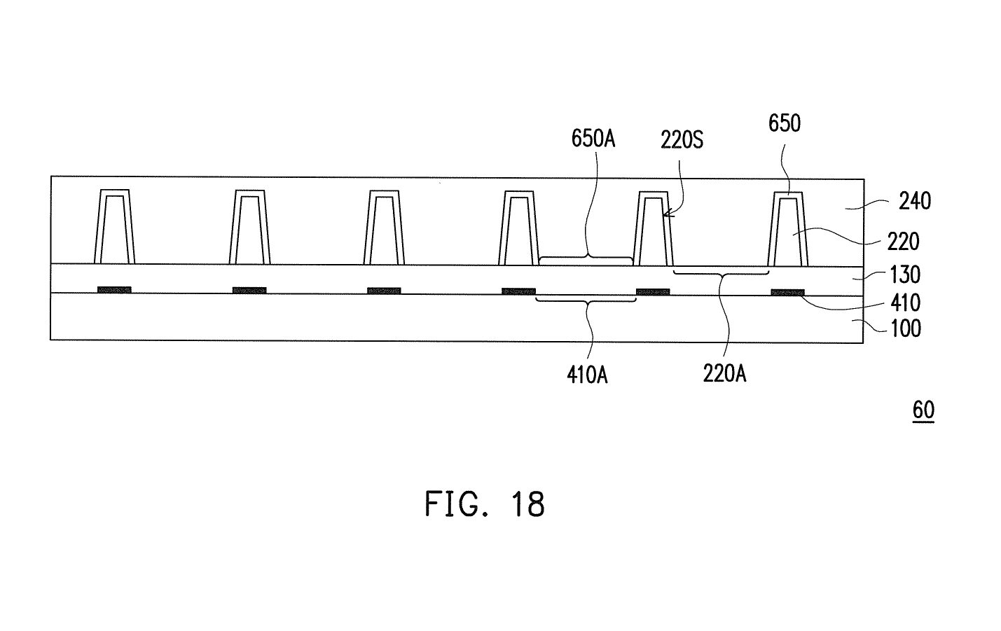

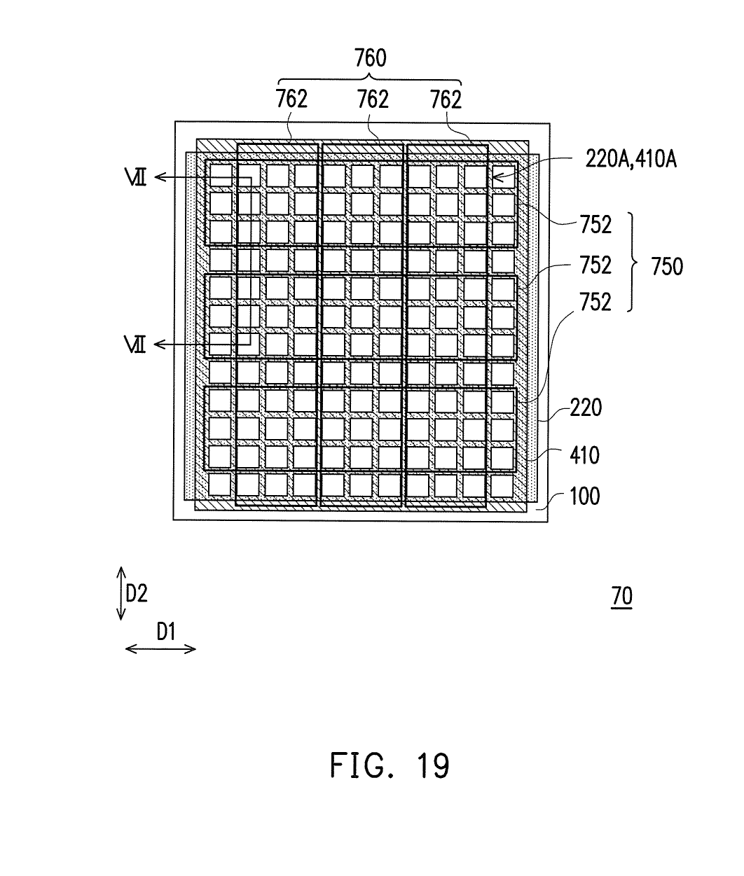

FIG. 17 is a schematic top view of a sensing device according to a sixth embodiment of the present disclosure. FIG. 18 is a schematic cross-sectional view of the sensing device of FIG. 17 along line VI-VI. Referring to FIG. 17 and FIG. 18, a sensing device 60 may include the substrate 100, the light shielding layer 410, the support structure 220, the cover layer 240, and a conductive layer 650. The light shielding layer 410 may be composed of an insulation material with high Young's modulus and disposed on the substrate 100, and has a plurality of first openings 410A. Also, the support structure 220 may be composed of an insulation material and disposed on the substrate 100. The light shielding layer 410 is located between the support structure 220 and the substrate 100. The support structure 220 has a plurality of second openings 220A, and a projection area of each first opening 410A overlaps a projection area of one second opening 220A. The cover layer 240 covers the support structure 220 and fills in the second opening 220A. Young's modulus of the support structure 220 is greater than the cover layer 240, and a refractive index of the support structure 220 having anti-impact ability is less than a refractive index of the cover layer 240. In addition, the conductive layer 650 is disposed between the cover layer 240 and the substrate 100 and has a plurality of third openings 650A corresponding to the first openings 410A, wherein the conductive layer 650 may include a plurality of first electrode patterns 652 separated from one another. In other embodiments, the conductive layer 650 may be selectively disposed between the support structure 220 and the intermediate layer 130, or between the light shielding layer 410 and the intermediate layer 130. Alternatively, the light shielding layer 410 may be selectively disposed between the intermediate layer 130 and the conductive layer 650. The intermediate layer 130 may include a plurality of color filter patterns referring to the intermediate layer 130′ of FIG. 2B.

In the embodiment, the conductive layer 650 is composed of a conductive material. The sensing device 60 is a one-layer electrode touch panel, wherein each first electrode pattern 652 may perform a self-capacitance sensing. In addition, the intermediate layer 130 of the sensing device 60 may be disposed between the support structure 220 and the light shielding layer 410. The insulating support structure 220 is not used as a touch electrode. By the selection of the material in the embodiment, the refractive index of the insulating support structure 220 is less than that of the cover layer 240. Also, the support structure 220 may have the sidewall 220S which can be sloped or not. When the sensing device 60 is applied to the display device 1 as shown in FIG. 4 and substituted for the sensing device 10 of FIG. 4, disposition of the support structure 220 and the cover layer 240 may enhance the ability of the display device in resisting impact or external force, and may also guide the light L emitted from the display layer DL to emit out collectively from the first opening 410A, so as to enhance the display performance of the display device. Additionally, the light shielding layer 410 of the embodiment may not be used as a touch electrode.

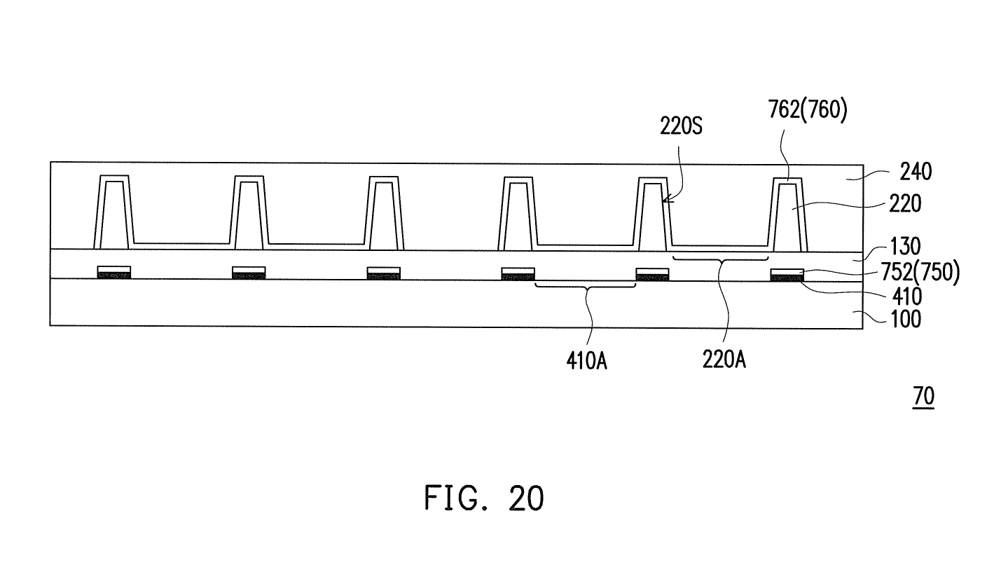

FIG. 19 is a schematic top view of a sensing device according to a seventh embodiment of the present disclosure. FIG. 20 is a schematic cross-sectional view of the sensing device of FIG. 19 along line VII-VII. Referring to FIG. 19 and FIG. 20 at the same time, a sensing device 70 may include the substrate 100, the light shielding layer 410, the support structure 220, the intermediate layer 130, the cover layer 240, a first conductive layer 750, and a second conductive layer 760. The substrate 100, the light shielding layer 410, the support structure 220, the intermediate layer 130, and the cover layer 240 may be similar to the sensing device 60 of FIG. 17, and thus will not be repeated. The intermediate layer 130 may include a plurality of color filter patterns referring to the intermediate layer 130′ of FIG. 2B. In one embodiment, each second opening 220A and one corresponding first opening 410A may have different sizes or shapes. For example, a projection area of the first opening 410A may overlap a projection area of the corresponding second opening 220A in a ratio equal to or more than 50% of the entire projection area of the first opening 410A.

In the embodiment, the first conductive layer 750 may be disposed between the substrate 100 and the intermediate layer 130 and include a plurality of first electrode patterns 752. The second conductive layer 760 may be disposed between the intermediate layer 130 and the cover layer 240 and include a plurality of second electrode patterns 762. The first electrode patterns 752 may be strip-shaped patterns respectively and extends along the first direction D1 while the second electrode patterns 762 may be strip-shaped patterns respectively and extends along the second direction D2, wherein the first direction D1 and the second direction D2 may intersect with each other. The intermediate layer 130 used for isolation is located between the first electrode patterns 752 and the second electrode patterns 762. Thus, a touch capacitance may be generated between the first electrode pattern 752 and the second electrode pattern 762 in the sensing device 70 to achieve a touch sensing function. The sensing device 70 of the embodiment may be a dual layer touch electrode touch panel.

When a sensing device of an embodiment of the present disclosure has a support structure having anti-impact ability applied to a display device, an external striking force may be absorbed or buffered to prevent from the damage of the electronic elements or the display equipment, and the display light may be guided to centralize within and emit out from openings. When a sensing device of an embodiment of the present disclosure applied to a display device, the ability of resisting impact and the display contrast of the display device may be enhanced. In addition, in sensing devices of some embodiments, at least one of the light shielding layer and the support structure having anti-impact function is composed of a conductive material and thereby not only provide the ability of resisting impact, a light shielding effect or a light guiding effect in optics but are used as touch electrodes.

Although the present disclosure has been described with reference to the above embodiments, it is clear that modifications to the described embodiments may be made without departing from the spirit of the present disclosure. Accordingly, the scope of the present disclosure will be defined by the attached claims and their equivalents not by the above detailed descriptions.

What is claimed is:

1. A sensing device, comprising:
a substrate;
a light shielding layer disposed on the substrate and having a plurality of first openings;
a support structure disposed on the substrate and having a plurality of second openings, wherein a projection area of each first opening overlaps a projection area of one second opening, and the light shielding layer is located between the support structure and the substrate; and
an intermediate layer disposed between the light shielding layer and the support structure, wherein at least one of the light shielding layer and the support structure is conductive and comprises a plurality of first electrode patterns separated from one another.

2. The sensing device according to claim 1, wherein the support structure comprises independent column structures or a continuous and repeatable lattice-shaped structure.

3. The sensing device according to claim 1, further comprising a cover layer covering the support structure and filling the second openings, wherein a Young's modulus of the support structure is greater than a Young's modulus of the cover layer.

4. The sensing device according to claim 1, wherein another one of the light shielding layer and the support structure is conductive and comprises a plurality of second electrode patterns separated from one another, and an extending direction of each first electrode pattern is interleaved with an extending direction of each second electrode pattern.

5. The sensing device according to claim 1, further comprising a conductive layer comprising a plurality of second electrode patterns, wherein the intermediate layer is located between the first electrode patterns and the second electrode patterns, and the. first electrode patterns are interleaved with the second electrode patterns.

6. The sensing device according to claim 5, wherein the light shielding layer is conductive and comprises the first electrode patterns, and the intermediate layer is located between the conductive layer and the light shielding layer.

7. The sensing device according to claim 6, wherein the conductive layer is located between the intermediate layer and the support structure.

8. The sensing device according to claim 6, wherein the support structure is located between the intermediate layer and the conductive layer.

9. The sensing device according to claim 6, wherein a partial area of the conductive layer is located in an area of the second openings.

10. The sensing device according to claim 5, wherein the support structure is conductive and comprises the first electrode patterns, and the intermediate layer is located between the conductive layer and the support structure.

11. The sensing device according to claim 10, wherein the conductive layer is located between the intermediate layer and the light shielding layer.

12. The sensing device according to claim 10, wherein the light shielding layer is located between the intermediate layer and the conductive layer.

13. The sensing device according to claim 10, wherein a partial area of the conductive layer is located in an area of the first openings.

14. The sensing device according to claim 5, wherein each second electrode pattern has a plurality of third openings, and a projection area of each third opening overlaps a projection area of one first opening and a projection area of one second opening.

15. A sensing device, comprising:
a substrate;
a light shielding layer disposed on the substrate and having a plurality of first openings;
a support structure disposed on the substrate, wherein the light shielding layer is located between the support structure and the substrate, and the support structure has a plurality of second openings, wherein a projection area of each first opening overlaps a projection area of one second opening;
a cover layer covering the support structure and filled in the second openings, wherein a Young's modulus of the support structure is greater than a Young's modulus of the cover layer; and
a first conductive layer disposed between the cover layer and the substrate, wherein the first conductive layer comprises a plurality of first electrode patterns separated from one another.

16. The sensing device according to claim 15, further comprising an intermediate layer disposed between the light shielding layer and the support structure.

17. The sensing device according to claim 16, further comprising a second conductive layer disposed between the cover layer and the substrate and comprising a plurality of second electrode patterns, wherein the first electrode patterns are interleaved with the second electrode patterns, and the intermediate layer is located between the first conductive layer and the second conductive layer.

18. The sensing device according to claim 15, wherein the first conductive layer is located between the cover layer and the support structure.

19. The sensing device according to claim 15, wherein the first conductive layer is located between the support structure and the light shielding layer.

20. The sensing device according to claim 15, wherein the first conductive layer is located between the substrate and the light shielding layer.
